(19) United States
(12) Patent Application Publication
(10) Pub. No.: US 2026/0133610 A1
(43) Pub. Date: May 14, 2026

(54) HINGE AND HINGE MODULE FOR FOLDABLE MOBILE TERMINAL HAVING FLEXIBLE SCREEN

(71) Applicant: Hangzhou Amphenol Phoenix Telecom Parts Co., Ltd., Hangzhou, Zhejiang (CN)

(72) Inventors: Huaqiao HU, Hangzhou, Zhejiang (CN); Pingju ZENG, Hangzhou, Zhejiang (CN)

(21) Appl. No.: 19/479,521

(22) PCT Filed: Mar. 25, 2024
(86) PCT No.: PCT/CN2024/083475

§ 371 Date: Oct. 28, 2025

(30) Foreign Application Priority Data
Apr. 12, 2023 (CN) 202310415432.8

(51) Int. Cl. G06F 1/16

(52) U.S. Cl. CPC G06F 1/1681; G06F 1/1652

(57) ABSTRACT

In a hinge and a hinge module for a foldable mobile terminal having a flexible screen, left and right motion structures each have a rotatable connecting arm, the rotatable connecting arm is rotatably mounted on a middle connecting frame, and each motion structure further includes a push-pull connecting rod mechanism and a sliding connecting frame. The push-pull connecting rod mechanism and the middle connecting frame are rotatably connected. The sliding connecting frame is slidably connected to the rotatable connecting arm, and the push-pull connecting rod mechanism is connected to the sliding connecting frame by a reverse stroke amplification connecting structure. The hinge structure can meet the movement requirements of flip-type mobile terminals having a flexible screen, allowing the flexible screen to flip from the inner side to the outer side of the mobile terminal, and vice versa.

### FIELD OF THE INVENTION

The present invention relates to a hinge and a hinge module for a foldable mobile terminal having a flexible screen. The mobile terminal may be a mobile phone, a laptop, etc.

### BACKGROUND OF THE INVENTION

There are two types of foldable mobile terminals having a flexible screen: inward-folding mobile terminals having a flexible screen and outward-folding mobile terminals having a flexible screen. For an outward-folding mobile terminal having a flexible screen, the flexible screen is located on the outer side when the mobile terminal is folded; for an inward-folding mobile terminal having a flexible screen, the flexible screen is located on the inner side when the mobile terminal is folded. The left and right housings of both inward-folding and outward-folding mobile terminals having a flexible screen are connected by a hinge, which enables folding and flattening (180°) of the flexible screen. However, after flattening, the mobile terminal cannot rotate further in the opposite folding direction; specifically, an inward-folding mobile terminal having a flexible screen cannot perform outward-folding movement, and an outward-folding mobile terminal having a flexible screen cannot perform inward-folding movement.

Reports have emerged about flip-type mobile terminals having a flexible screen capable of both inward and outward folding. Such terminals can be opened from an inward-folding closed state to a flattened state, and further opened beyond 180° (e.g., up to 300° or to an outward-folding closed state). However, most of these flip-type mobile terminals having a flexible screen only achieve U-shaped bending at the inward-folding part. As a result, a relatively wide gap is formed between the closed left and right housings when the flip-type terminal is in the inward-folding closed state, affecting its appearance. If a waterdrop-shaped recess is formed at the inward-folding part to ensure a narrow and evenly wide gap between the left and right housings when closed, the left and right housings currently need to have a sliding stroke. However, for large-sized mobile terminals having a flexible screen, it is difficult to achieve a large sliding stroke while ensuring the outward-folding function, which limits the application of the dual inward/outward folding function in large-sized mobile terminals having a flexible screen.

### SUMMARY OF THE INVENTION

A first object of the present invention is to provide a hinge for a foldable mobile terminal having a flexible screen. The hinge is suitable for flip-type movement exceeding 180° and is particularly applicable to large-sized mobile terminals having a flexible screen (e.g., laptops having a flexible screen). When the foldable mobile terminal having a flexible screen moves from an inward-folding closed state to a flattened state and then to the maximum outward-folding angle, the hinge enables the left and right housings of the terminal to slide with a larger stroke away from the middle connecting frame, while facilitating the concealment of the middle structure. To achieve the object, the present invention adopts the following technical solutions:

A hinge for a foldable mobile terminal having a flexible screen, comprising left and right motion structures, wherein the left motion structure and the right motion structure each have a rotatable connecting arm, the rotatable connecting arm is rotatably mounted on a middle connecting frame, and a synchronous reverse rotation connecting mechanism is connected between the left and right motion structures; each motion structure further comprises a push-pull connecting rod mechanism and a sliding connecting frame;
the push-pull connecting rod mechanism and the middle connecting frame are rotatably connected;
the sliding connecting frame is slidably connected to the rotatable connecting arm;
the push-pull connecting rod mechanism is connected to the sliding connecting frame by means of a reverse stroke amplification connecting structure, the axis of rotational connection between the push-pull connecting rod mechanism and the middle connecting frame, and the axis of rotation of the rotatable connecting arm, are arranged such that: when the foldable mobile terminal having a flexible screen moves from an inward-folding closed state to a flattened state and then to a maximum outward-folding angle, a connection part between the push-pull connecting rod mechanism and the reverse stroke amplification connecting structure moves away from the middle connecting frame, and this movement is converted by the reverse stroke amplification connecting structure into a displacement of the sliding connecting frame toward the middle connecting frame, with the sliding displacement of the sliding connecting frame being greater than that of the connection part between the push-pull connecting rod mechanism and the reverse stroke amplification connecting structure; when the foldable mobile terminal having a flexible screen moves from the maximum outward-folding angle to the flattened state and then to the inward-folding closed state, the connection part between the push-pull connecting rod mechanism and the reverse stroke amplification connecting structure moves toward the middle connecting frame, and this movement is converted by the reverse stroke amplification connecting structure into a displacement of the sliding connecting frame away from the middle connecting frame, with the sliding displacement of the sliding connecting frame being greater than that of the connection part between the push-pull connecting rod mechanism and the reverse stroke amplification connecting structure.

On the basis of the above technical solution, the present invention may further adopt the following technical solutions or a combination thereof:
with the foldable mobile terminal having a flexible screen in the flattened state as a reference state, the axis of rotational connection between the push-pull connecting rod mechanism and the middle connecting frame is located below the axis of rotation of the rotatable connecting arm, the push-pull connecting rod mechanism comprises a first connecting rod and a second connecting rod, an inner end of the first connecting rod is rotatably connected to the middle connecting frame, an outer end of the first connecting rod is rotatably connected to an inner end of the second connecting rod, and an outer end of the second connecting rod is connected to the reverse stroke amplification connecting structure;
the second connecting rod is also slidably connected to the rotatable connecting arm, the position of a slide rail for the sliding connection, the position of the axis of rotational connection between the first connecting rod and the middle connecting frame, and the position of the axis of rotational connection between the first connecting rod and the second connecting rod are coordinated such that, when the foldable mobile terminal having a flexible screen is in the inward-folding closed state, the axis of rotational connection between the first connecting rod and the middle connecting frame is closer to a center line of the middle connecting frame than the axis of rotational connection between the first connecting rod and the second connecting rod.

The reverse stroke amplification connecting structure adopts a two-segment connecting rod mechanism, comprising a third connecting rod and a fourth connecting rod, the third connecting rod and the fourth connecting rod are rotatably connected, and a rotatable connecting shaft thereof is constrained to move parallel to the axis of rotation of the rotatable connecting arm, the other end of the third connecting rod is rotatably connected to the push-pull connecting rod mechanism, and the other end of the fourth connecting rod is rotatably connected to the sliding connecting frame; the length of the third connecting rod is greater than that of the fourth connecting rod, and the axis of rotational connection between the third and fourth connecting rods, the axis of rotational connection between the third connecting rod and the push-pull connecting rod mechanism, and the axis of rotational connection between the fourth connecting rod and the sliding connecting frame are all perpendicular to the axis of rotation of the rotatable connecting arm.

The reverse stroke amplification connecting structure adopts a two-segment connecting rod mechanism, comprising a third connecting rod and a fourth connecting rod, each of the third connecting rod and the fourth connecting rod is composed of two connecting rods that are rotatably connected, the third connecting rod and the fourth connecting rod are rotatably connected to form a quadrilateral connecting rod mechanism, and the length of the third connecting rod is greater than that of the fourth connecting rod; the third connecting rod and the fourth connecting rod are rotatably connected, and a rotatable connecting shaft thereof is constrained to move parallel to the axis of rotation of the rotatable connecting arm, the other end of the third connecting rod is rotatably connected to the push-pull connecting rod mechanism, and the other end of the fourth connecting rod is rotatably connected to the sliding connecting frame; the axis of rotational connection between the third and fourth connecting rods, the axis of rotational connection between the third connecting rod and the push-pull connecting rod mechanism, and the axis of rotational connection between the fourth connecting rod and the sliding connecting frame are all perpendicular to the axis of rotation of the rotatable connecting arm.

A second object of the present invention is to provide a hinge module applying the above hinge. To achieve the object, the present invention adopts the following technical solutions:

A hinge module for a foldable mobile terminal having a flexible screen, comprising two hinges according to claim 1, which are respectively disposed at a first end and a second end of the middle connecting frame, the hinge module comprises a linkage module at the first end and a linkage module at the second end, and the linkage modules control synchronous reverse rotation of the left and right motion structures of the hinges within an outward-folding stroke range and an inward-folding stroke range;
a plurality of sequentially arranged middle support plates that rotate with the linkage modules are connected between the linkage module at the first end and the linkage module at the second end, forming an integral chain-plate-shaped rotating assembly; the plurality of middle support plates are used to support the flexible screen, when the foldable mobile terminal having a flexible screen is in the flattened state, the plurality of middle support plates are spliced into a flexible screen support structure, when the foldable mobile terminal having a flexible screen is in the inward-folding closed state, the plurality of middle support plates form a space for accommodating a curved middle part of the flexible screen;
the linkage modules adopt a multi-row chain-type rotatable connecting structure, gears are provided at ends of chain links, chain links in the same row are sequentially meshed and connected by means of the gears, and chain links in adjacent rows are rotatably connected by means of staggered shafts, shafts connected to both ends of a middle chain link of the linkage module are connected to the middle connecting frame, and shafts connected to both ends of chain links in a row where the middle chain link is located are correspondingly connected to the same middle support plate.

On the basis of the above technical solution, the present invention may further adopt the following technical solutions or a combination thereof:

With the foldable mobile terminal having a flexible screen in the flattened state as a reference state, the axis of rotational connection between the push-pull connecting rod mechanism and the middle connecting frame is located below the axis of rotation of the rotatable connecting arm, the push-pull connecting rod mechanism comprises a first connecting rod and a second connecting rod, an inner end of the first connecting rod is rotatably connected to the middle connecting frame, an outer end of the first connecting rod is rotatably connected to an inner end of the second connecting rod, and an outer end of the second connecting rod is connected to the reverse stroke amplification connecting structure; the second connecting rod is also slidably connected to the rotatable connecting arm, the position of a slide rail for the sliding connection, the position of the axis of rotational connection between the first connecting rod and the middle connecting frame, and the position of the axis of rotational connection between the first connecting rod and the second connecting rod are coordinated such that, when the foldable mobile terminal having a flexible screen is in the inward-folding closed state, the axis of rotational connection between the first connecting rod and the middle connecting frame is closer to a center line of the middle connecting frame than the axis of rotational connection between the first connecting rod and the second connecting rod.

The first connecting rods of the hinges at the first end and the second end are combined into a plate extending from the first end to the second end, forming a shielding structure.

The hinge is provided with a locking structure for locking a current angle when the hinge is opened or folded to different angles.

A rotatable connecting shaft between the first connecting rod and the middle connecting frame is configured to slide axially, and an end thereof is provided as a lock head and supported axially by a spring, a plurality of lock grooves matching the lock head are provided around a rotatable connecting shaft of the rotatable connecting arm.

The shafts connected to both ends of the middle chain link are rotatably connected to the middle connecting frame, and both ends of the linkage module are rotatably connected to the rotatable connecting arms of the left motion structure and the right motion structure at positions offset from the axis of rotation of the rotatable connecting arms.

The number of chain links in the row where the middle chain link is located is five, the number of middle support plates is five, and the width of the middle support plates on both sides is greater than that of the three middle support plates therebetween.

Both ends of the linkage module are rotatably connected to the rotatable connecting arms of the left motion structure and the right motion structure at positions offset from the axis of rotation of the rotatable connecting arms.

At least some of the middle support plates support the curved middle part of the flexible screen when the foldable mobile terminal having a flexible screen is in an outward-folding closed state.

The hinge structure of the present invention enables movement of the mobile terminal from inward-folding opening, flattening, further rotation to outward-folding, and from outward-folding to flattening, further rotation to inward-folding closing. The overall stroke can be 360° or an angle greater than 180° but less than 360° (e.g., 300°), meeting the movement requirements of flip-type mobile terminals having a flexible screen. This allows the flexible screen to flip from the inner side to the outer side of the mobile terminal, and vice versa. In addition, the hinge structure enables the left and right housings to slide with a large stroke, making it suitable for large-sized flip-type mobile terminals having a flexible screen to achieve a waterdrop-shaped recess during inward folding. When applied to flip-type laptops having a flexible screen, the hinge structure ensures a narrow, uniform gap between the left and right housings when closed, while making it easier to conceal the middle structure.

### BRIEF DESCRIPTION OF THE DRAWINGS

FIG. 1 is a rear schematic view of an embodiment of a hinge of the present invention when a corresponding mobile terminal having a flexible screen is flattened.

FIG. 2 is a front view of an embodiment of a hinge of the present invention when a corresponding mobile terminal having a flexible screen is flattened.

FIG. 3 is a front schematic view of an embodiment of a hinge of the present invention when a corresponding mobile terminal having a flexible screen is flattened.

FIG. 4 is a schematic view of an embodiment of a hinge of the present invention when a corresponding mobile terminal having a flexible screen is in the inward-folding closed state.

FIG. 5 is a front view of an embodiment of a hinge of the present invention when a corresponding mobile terminal having a flexible screen is in the inward-folding closed state.

FIG. 6 is a front view of an embodiment of a hinge of the present invention when a corresponding mobile terminal having a flexible screen is opened to 300°.

FIG. 7 is an inner side schematic view of an embodiment of a hinge of the present invention when a corresponding mobile terminal having a flexible screen is opened to 300°.

FIG. 8 is a schematic view of a combined structure of a middle support structure and a synchronous reverse rotation connecting mechanism in an embodiment of a hinge of the present invention when a corresponding mobile terminal having a flexible screen is in the inward-folding closed state.

FIG. 9 is a schematic view of a combined structure of a middle support structure and a synchronous reverse rotation connecting mechanism in an embodiment of a hinge of the present invention when a corresponding mobile terminal having a flexible screen is opened to 300°.

FIG. 10 is a front view of a combined structure of a middle support structure and a synchronous reverse rotation connecting mechanism in an embodiment of a hinge of the present invention when a corresponding mobile terminal having a flexible screen is opened to 300°.

FIG. 11 is an exploded schematic view of a linkage module in an embodiment of the present invention.

FIG. 12 is an exploded schematic view of an embodiment of a hinge of the present invention.

FIGS. 13, 14, and 15 are schematic views of a mobile terminal having a flexible screen of the present invention in the inward-folding closed state, flattened state, and outward-folding state (opened to 300°), respectively.

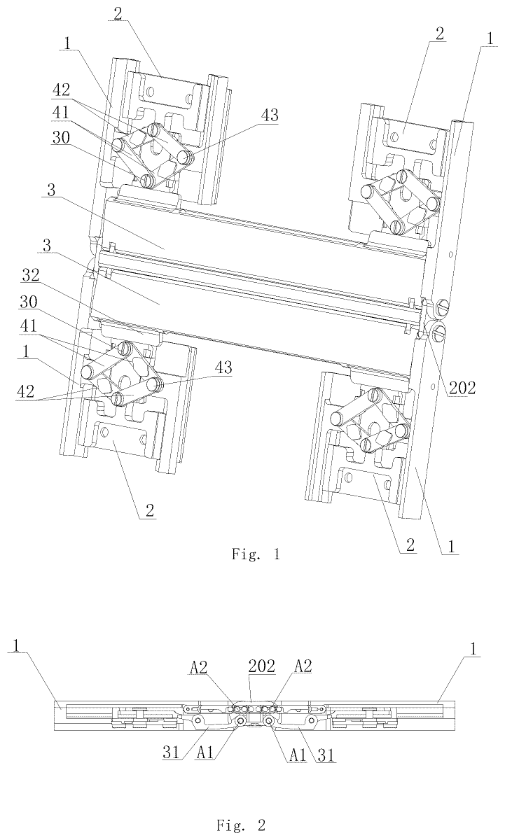

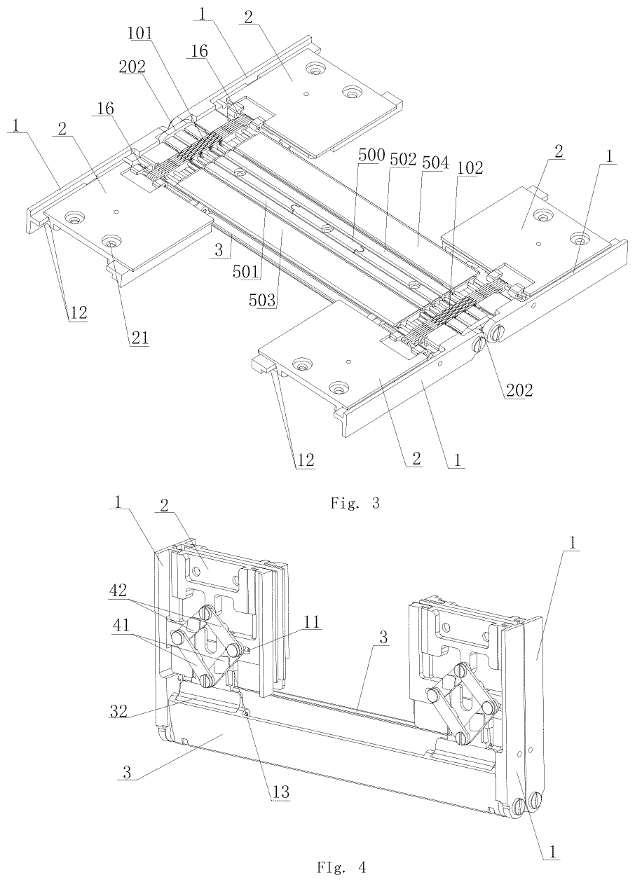

### DETAILED DESCRIPTION

The foldable mobile terminal having a flexible screen applying the hinge of the present invention can be implemented as a flip-type mobile terminal having a flexible screen. The foldable mobile terminal having a flexible screen includes a left housing, a right housing, and the hinge of the present invention connected to the left and right housings, with a flexible screen 100 laid on one side of the mobile terminal having a flexible screen. The first 180° of rotation from the closed state to the flattened state is the inward-folding opening process; rotation beyond 180° to the maximum rotation angle (e.g., 360° or an angle less than 360° such as 300°) is the outward-folding process. The reverse process includes flattening and inward-folding closing.

Referring to the figures, the hinge of the present invention includes left and right motion structures. The left motion structure and the right motion structure each have a rotatable connecting arm 1, and the rotatable connecting arms 1 are rotatably mounted on a middle connecting frame. A synchronous reverse rotation connection mechanism is connected between the left and right motion structures. Each motion structure further includes a push-pull connecting rod mechanism and a sliding connecting frame 2.

The push-pull connecting rod mechanism and the middle connecting frame are rotatably connected. In the mobile terminal of this embodiment, the middle connecting frame is formed by fixedly connecting a middle connecting structure 201 and end connecting bases 202 at both ends by means of screws.

The sliding connecting frame 2 is slidably connected to the rotatable connecting arm 1, and a slide rail matching structure 12 perpendicular to the axis of rotation of the rotatable connecting arm 1 is provided therebetween.

The sliding connecting frames 2 of the left and right motion structures are respectively provided with parts, for example, screw connection holes 21, for connecting to the left housing 301 and the right housing 302 of the foldable mobile terminal having a flexible screen. The left housing 301 and the right housing 302 are respectively connected to the sliding connecting frames 2 of the left and right motion structures.

The push-pull connecting rod mechanism is connected to the sliding connecting frame 2 by means of a reverse stroke amplification connecting structure, the axis of rotational connection between the push-pull connecting rod mechanism and the middle connecting frame, and the axis of rotation of the rotatable connecting arm 1, are arranged such that: when the foldable mobile terminal having a flexible screen moves from an inward-folding closed state to a flattened state and then to a maximum outward-folding angle, a connection part 30 between the push-pull connecting rod mechanism and the reverse stroke amplification connecting structure moves away from the middle connecting frame, and this movement is converted by the reverse stroke amplification connecting structure into a displacement of the sliding connecting frame 2 toward the middle connecting frame, with the sliding displacement of the sliding connecting frame 2 being greater than that of the connection part 30 between the push-pull connecting rod mechanism and the reverse stroke amplification connecting structure; when the foldable mobile terminal having a flexible screen moves from the maximum outward-folding angle to the flattened state and then to the inward-folding closed state, the connection part 30 between the push-pull connecting rod mechanism and the reverse stroke amplification connecting structure moves toward the middle connecting frame, and this movement is converted by the reverse stroke amplification connecting structure into a displacement of the sliding connecting frame 2 away from the middle connecting frame, with the sliding displacement of the sliding connecting frame 2 being greater than that of the connection part 30 between the push-pull connecting rod mechanism and the reverse stroke amplification connecting structure. Through reverse amplification, the push-pull connecting rod mechanism can better shield the wiring between the left and right housings 301, 302, the linkage modules described below, and other components at the top of the middle part of the mobile terminal having a flexible screen when the mobile terminal is in the inward-folding closed state. In addition, a larger linear displacement of the sliding connecting frame can be obtained, meeting the requirement for a waterdrop-shaped recess during inward folding of large-sized flip-type mobile terminals having a flexible screen.

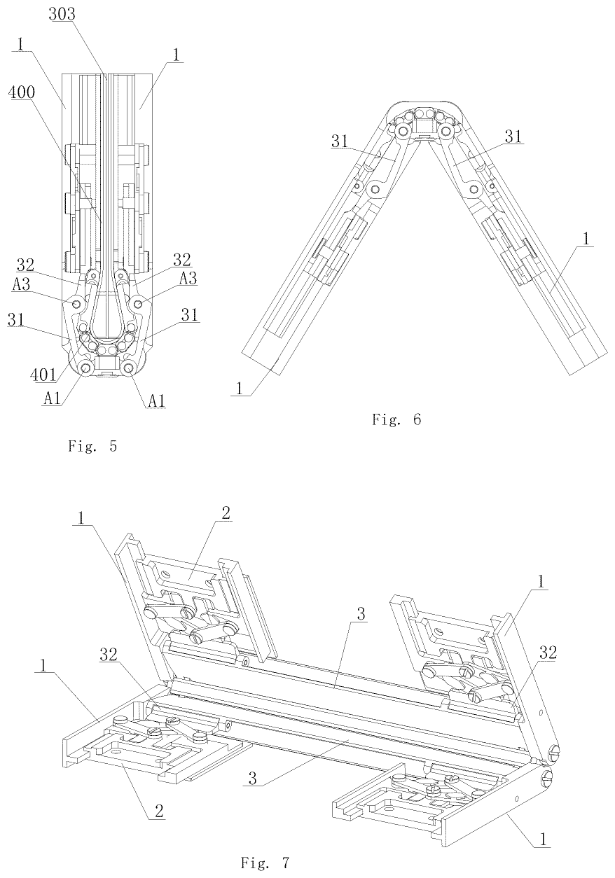

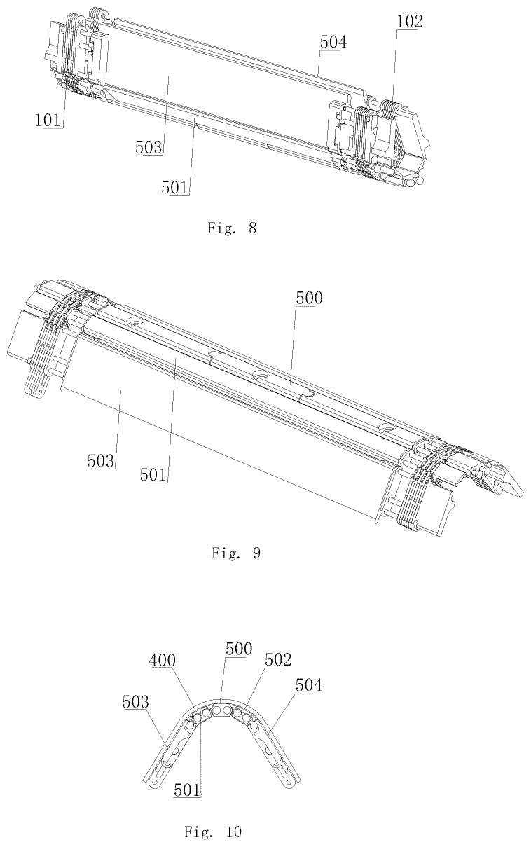

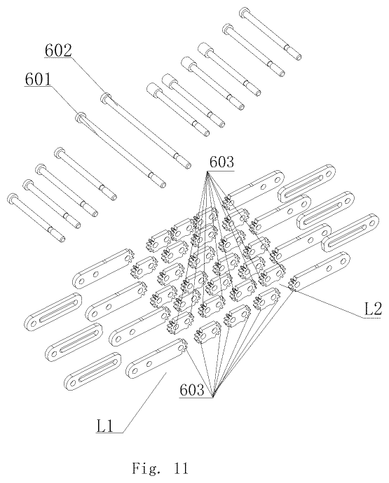

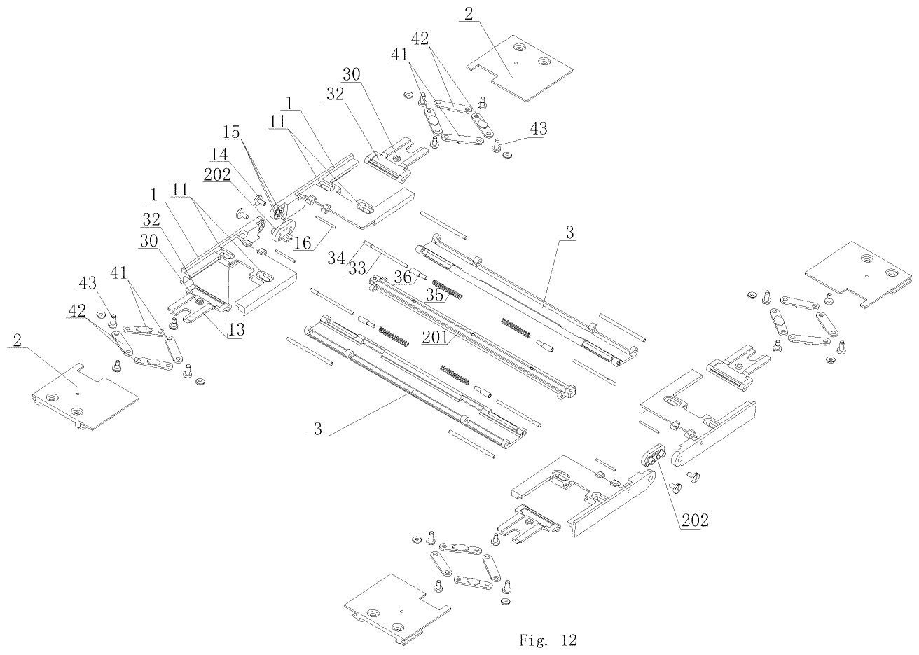

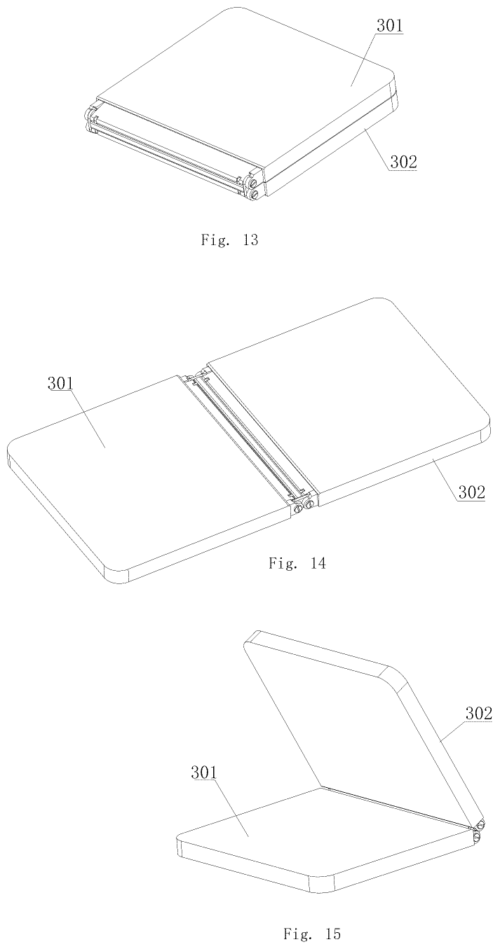

With the foldable mobile terminal having a flexible screen in the flattened state as the reference state, the axis A1 of rotational connection between the push-pull connecting rod mechanism and the middle connecting frame is located below the axis A2 of rotation of the rotatable connecting arm 1. In this embodiment, the push-pull connecting rod mechanism is composed of a first connecting rod 31 and a second connecting rod 32, the inner end of the first connecting rod 31 is rotatably connected to the middle connecting frame, the outer end of the first connecting rod 31 is rotatably connected to the inner end of the second connecting rod 32, and the outer end of the second connecting rod 32 is rotatably connected to the reverse stroke amplification connecting structure. The second connecting rod 32 is also slidably connected to the rotatable connecting arm 1, and the slide rail matching structure 13 therebetween is parallel to the slide rail matching structure 12 between the sliding connecting frame 2 and the rotatable connecting arm 1. The position of the slide rail structure (slide rail matching structure 13) for the sliding connection, the position of the axis A1 of rotational connection between the first connecting rod 31 and the middle connecting frame, and the position of the axis A3 of rotational connection between the first connecting rod 31 and the second connecting rod 32 are coordinated such that, when the foldable mobile terminal having a flexible screen is in the inward-folding closed state (as shown in FIG. 5), the axis of rotational connection between the first connecting rod 31 and the middle connecting frame (i.e., the axis A1) is closer to the center line of the middle connecting frame (which may correspond to the joint 303 between the left housing 301 and the right housing 302 when in the inward-folding closed state) than the axis A3 of rotational connection between the first connecting rod 31 and the second connecting rod 32.

The reverse stroke amplification connecting structure adopts a two-segment connecting rod mechanism, including a third connecting rod 41 and a fourth connecting rod 42. Each of the third connecting rod 41 and the fourth connecting rod 42 is composed of two connecting rods that are rotatably connected. The third connecting rod 41 and the fourth connecting rod 42 are rotatably connected to form a quadrilateral connecting rod mechanism, and the length of the third connecting rod 41 is greater than that of the fourth connecting rod 42. The third connecting rod 41 and the fourth connecting rod 42 are rotatably connected, and the rotational connection shaft 43 thereof is constrained to move parallel to the axis A2 of rotation of the rotatable connecting arm. In practice, a horizontal guide hole 11 may be provided on the rotatable connecting arm 1 to slidably connect with the end of the rotational connection shaft 43. The other end of the third connecting rod 41 is rotatably connected to the second connecting rod 32 in the push-pull connecting rod mechanism, and the other end of the fourth connecting rod 42 is rotatably connected to the sliding connecting frame 2. The axis of rotational connection between the third connecting rod 41 and fourth connecting rod 42, the axis of rotational connection between the third connecting rod 41 and the push-pull connecting rod mechanism, and the axis of rotational connection between the fourth connecting rod 42 and the sliding connecting frame 2 are all perpendicular to the axis A2 of rotation of the rotatable connecting arm.

Further, by changing the length ratio of the third connecting rod 41 to the fourth connecting rod 42, different stroke magnifications can be obtained, making it easy to adapt to large-sized mobile terminals having a flexible screen of different sizes.

In practice, two hinges of the present invention may be used to form a hinge module. The two hinges are respectively disposed at the first end and the second end of the middle connecting frame. The hinge module includes a linkage module 101 at the first end and a linkage module 102 at the second end, and the linkage modules control the synchronous reverse rotation of the left and right motion structures of the hinges within the outward-folding stroke range and the inward-folding stroke range.

A plurality of sequentially arranged middle support plates that rotate with the linkage modules are connected between the linkage module 101 at the first end and the linkage module 102 at the second end, forming an integral chain-plate-shaped rotating assembly. The plurality of middle support plates are used to support the flexible screen 400, when the foldable mobile terminal having a flexible screen is in the flattened state, the plurality of middle support plates are spliced into a flexible screen support structure at the middle part of the mobile terminal having a flexible screen; when the terminal is in the inward-folding closed state, the plurality of middle support plates form a space for accommodating the waterdrop-shaped curved middle part 401 of the flexible screen.

The first connecting rods 31 of the hinges at the first end and the second end are combined into a plate 3 extending from the first end to the second end, forming a shielding structure that shields internal components at the middle part, such as the wiring between the left and right housings 301, 302 and the linkage modules 101, 102.

The hinge is provided with a locking structure for locking the current angle when the hinge is opened or folded to different angles. In this embodiment, three locking positions are provided, corresponding to the inward-folding closed state, the flattened state, and the maximum outward-folding angle (300°), respectively.

In this embodiment, the locking structure is integrated between the shaft 33 of the push-pull connecting rod and the rotatable connecting arm 1. Specifically, the rotational connection shaft 33 between the first connecting rod 31 and the middle connecting frame is configured to slide axially, and the end thereof is provided as a lock head 34 supported axially by a spring 35. A step structure 36 may be provided at the end of the rotational connection shaft 33 to match the spring 35, and the other end of the spring 35 is supported on the first connecting rod. Corresponding to the above states requiring locking, three lock grooves 15 matching the lock head are provided around the rotational connection shaft 14 of the rotatable connecting arm.

The linkage module 101 at the first end and the linkage module 102 at the second end adopt the same multi-row chain-type rotational connection structure. Gears are provided at the ends of the chain links. Chain links in the same row are sequentially meshed and connected by means of the gears, and chain links in adjacent rows are rotatably connected by means of staggered shafts. The middle parts of the linkage modules 101, 102 are connected to the connecting base 202 of the middle connecting frame by means of the shafts 601, 602 connected to both ends of a middle chain link. The shafts connected to both ends of the chain links in the row where the middle chain link is located are correspondingly connected to the same middle support plate 500.

In this embodiment, the number of chain links in the row where the middle chain link is located is five, and the number of middle support plates is five. The width of the middle support plates 503, 504 on both sides is greater than that of the three middle support plates 501, 502 therebetween. This enables the middle support plates inside the curved flexible screen to better simulate the curved shape and provide better support for the curved middle part of the flexible screen when the foldable mobile terminal having a flexible screen is in the outward-folding closed state.

The shafts connected to both ends of the middle chain link are rotatably connected to the middle connecting frame, and both ends of the linkage module are rotatably connected to the rotatable connecting arms of the left motion structure and the right motion structure at positions offset from the axis of rotation of the rotatable connecting arms.

The linkage module has a left-right symmetric structure, and the axes of rotation of the rotatable connecting arms 1 of the left motion structure and the right motion structure are also symmetric with respect to the symmetrical center line of the linkage module.

Both ends of the linkage module are rotatably connected to the rotatable connecting arms of the left motion structure and the right motion structure at positions offset from the axis of rotation of the rotatable connecting arms. The reference numeral 16 represents a connecting shaft.

The chain links of the linkage module are transmission plates. The multi-row chain-type rotational connection structure includes one or more rows of first-row transmission plates L1 and one or more rows of second-row transmission plates L2. The number of transmission plates in the first-row transmission plates L1 is odd (corresponding to the number of middle support plates, which is five), and the number of transmission plates in the second-row transmission plates L2 is even (four plates). As shown in the figures, the transmission plates of the first-row transmission plates L1 and the second-row transmission plates L2 are rotatably connected by means of staggered shafts. For transmission plates in the same row, gears 603 meshed with each other are provided at the adjacent ends of adjacent transmission plates to achieve synchronous movement. The transmission plates in the first-row transmission plates L1 may have different lengths but are symmetric with respect to the symmetrical center line of the linkage module; similarly, the transmission plates in the second-row transmission plates L2 may have different lengths but are symmetric with respect to the symmetrical center line of the linkage module.

The middle support plates 500, 501, 502, 503, 504, 505 are arranged and connected in one-to-one correspondence with the first-row transmission plates L1.

The foregoing description only describes the specific embodiments of the present invention, but the structural features of the present invention are not limited thereto. Any changes or modifications made by those skilled in the art within the field of the present invention shall fall within the scope of protection of the present invention.

It should be noted that the terms “comprising” and “having” in the description and claims of the present invention and the accompanying drawings, as well as any modifications thereof, are intended to cover non-exclusive inclusion. The terms “installed/mounted”, “arranged”, “set”, “connected”, “sleeved” should be construed broadly. For example, it may be a fixed connection, a detachable connection, or an integral structure; it may be a mechanical connection, or an electrical connection; it may be directly connected, or indirectly connected through an intermediary, or between two devices, elements, or internal communication between components. For those of ordinary skill in the art, the specific meanings of the above terms in the present invention can be understood according to specific situations.

It should be understood that, in the description of the present invention, the orientation or positional relationship indicated by the terms “one end”, “another end”, “outside”, “inside”, “horizontal”, “end”, “length”, “outer end”, “left”, “right”, etc. is based on the orientation or positional relationship shown in the figures, and is only for the convenience of describing the present invention and simplifying the description, rather than indicating or implying that the indicated device or element must have the particular orientation, construction and operation in the particular orientation, therefore, it cannot be construed as limitations of the present invention. The terms “first”, “second” are used for brevity of description only, and do not indicate or imply relative importance.

Furthermore, in practicing the appended claims of the present invention, variations to the disclosed embodiments may be understood and effected by those skilled in the art through a study of the drawings, the disclosure, and the appended claims. In addition, in the claims and the specification, words such as “comprise/comprising”, “include/including”, and the like do not exclude other elements or steps, and non-plural nouns do not exclude plural forms thereof.

1. A hinge for a foldable mobile terminal having a flexible screen, comprising left and right motion structures, wherein the left motion structure and the right motion structure each have a rotatable connecting arm, the rotatable connecting arm is rotatably mounted on a middle connecting frame, and a synchronous reverse rotation connecting mechanism is connected between the left and right motion structures; each motion structure further comprises a push-pull connecting rod mechanism and a sliding connecting frame;
the push-pull connecting rod mechanism and the middle connecting frame are rotatably connected;
the sliding connecting frame is slidably connected to the rotatable connecting arm;
the push-pull connecting rod mechanism is connected to the sliding connecting frame by means of a reverse stroke amplification connecting structure, the axis of rotational connection between the push-pull connecting rod mechanism and the middle connecting frame, and the axis of rotation of the rotatable connecting arm, are arranged such that: when the foldable mobile terminal having a flexible screen moves from an inward-folding closed state to a flattened state and then to a maximum outward-folding angle, a connection part between the push-pull connecting rod mechanism and the reverse stroke amplification connecting structure moves away from the middle connecting frame, and this movement is converted by the reverse stroke amplification connecting structure into a displacement of the sliding connecting frame toward the middle connecting frame, with the sliding displacement of the sliding connecting frame being greater than that of the connection part between the push-pull connecting rod mechanism and the reverse stroke amplification connecting structure; when the foldable mobile terminal having a flexible screen moves from the maximum outward-folding angle to the flattened state and then to the inward-folding closed state, the connection part between the push-pull connecting rod mechanism and the reverse stroke amplification connecting structure moves toward the middle connecting frame, and this movement is converted by the reverse stroke amplification connecting structure into a displacement of the sliding connecting frame away from the middle connecting frame, with the sliding displacement of the sliding connecting frame being greater than that of the connection part between the push-pull connecting rod mechanism and the reverse stroke amplification connecting structure.

2. The hinge for a foldable mobile terminal having a flexible screen according to claim 1, wherein with the foldable mobile terminal having a flexible screen in the flattened state as a reference state, the axis of rotational connection between the push-pull connecting rod mechanism and the middle connecting frame is located below the axis of rotation of the rotatable connecting arm, the push-pull connecting rod mechanism comprises a first connecting rod and a second connecting rod, an inner end of the first connecting rod is rotatably connected to the middle connecting frame, an outer end of the first connecting rod is rotatably connected to an inner end of the second connecting rod, and an outer end of the second connecting rod is connected to the reverse stroke amplification connecting structure;
the second connecting rod is also slidably connected to the rotatable connecting arm, the position of a slide rail for the sliding connection, the position of the axis of rotational connection between the first connecting rod and the middle connecting frame, and the position of the axis of rotational connection between the first connecting rod and the second connecting rod are coordinated such that, when the foldable mobile terminal having a flexible screen is in the inward-folding closed state, the axis of rotational connection between the first connecting rod and the middle connecting frame is closer to a center line of the middle connecting frame than the axis of rotational connection between the first connecting rod and the second connecting rod.

3. The hinge for a foldable mobile terminal having a flexible screen according to claim 1, wherein the reverse stroke amplification connecting structure adopts a two-segment connecting rod mechanism, comprising a third connecting rod and a fourth connecting rod, the third connecting rod and the fourth connecting rod are rotatably connected, and a rotatable connecting shaft thereof is constrained to move parallel to the axis of rotation of the rotatable connecting arm, the other end of the third connecting rod is rotatably connected to the push-pull connecting rod mechanism, and the other end of the fourth connecting rod is rotatably connected to the sliding connecting frame; the length of the third connecting rod is greater than that of the fourth connecting rod, and the axis of rotational connection between the third and fourth connecting rods, the axis of rotational connection between the third connecting rod and the push-pull connecting rod mechanism, and the axis of rotational connection between the fourth connecting rod and the sliding connecting frame are all perpendicular to the axis of rotation of the rotatable connecting arm.

4. The hinge for a foldable mobile terminal having a flexible screen according to claim 1, wherein the reverse stroke amplification connecting structure adopts a two-segment connecting rod mechanism, comprising a third connecting rod and a fourth connecting rod, each of the third connecting rod and the fourth connecting rod is composed of two connecting rods that are rotatably connected, the third connecting rod and the fourth connecting rod are rotatably connected to form a quadrilateral connecting rod mechanism, and the length of the third connecting rod is greater than that of the fourth connecting rod; the third connecting rod and the fourth connecting rod are rotatably connected, and a rotatable connecting shaft thereof is constrained to move parallel to the axis of rotation of the rotatable connecting arm, the other end of the third connecting rod is rotatably connected to the push-pull connecting rod mechanism, and the other end of the fourth connecting rod is rotatably connected to the sliding connecting frame; the axis of rotational connection between the third and fourth connecting rods, the axis of rotational connection between the third connecting rod and the push-pull connecting rod mechanism, and the axis of rotational connection between the fourth connecting rod and the sliding connecting frame are all perpendicular to the axis of rotation of the rotatable connecting arm.

5. A hinge module for a foldable mobile terminal having a flexible screen, comprising two hinges according to claim 1, which are respectively disposed at a first end and a second end of the middle connecting frame, the hinge module comprises a linkage module at the first end and a linkage module at the second end, and the linkage modules control synchronous reverse rotation of the left and right motion structures of the hinges within an outward-folding stroke range and an inward-folding stroke range;
a plurality of sequentially arranged middle support plates that rotate with the linkage modules are connected between the linkage module at the first end and the linkage module at the second end, forming an integral chain-plate-shaped rotating assembly; the plurality of middle support plates are used to support the flexible screen, when the foldable mobile terminal having a flexible screen is in the flattened state, the plurality of middle support plates are spliced into a flexible screen support structure, when the foldable mobile terminal having a flexible screen is in the inward-folding closed state, the plurality of middle support plates form a space for accommodating a curved middle part of the flexible screen;
the linkage modules adopt a multi-row chain-type rotatable connecting structure, gears are provided at ends of chain links, chain links in the same row are sequentially meshed and connected by means of the gears, and chain links in adjacent rows are rotatably connected by means of staggered shafts, shafts connected to both ends of a middle chain link of the linkage module are connected to the middle connecting frame, and shafts connected to both ends of chain links in a row where the middle chain link is located are correspondingly connected to the same middle support plate.

6. The hinge module for a foldable mobile terminal having a flexible screen according to claim 5, wherein with the foldable mobile terminal having a flexible screen in the flattened state as a reference state, the axis of rotational connection between the push-pull connecting rod mechanism and the middle connecting frame is located below the axis of rotation of the rotatable connecting arm, the push-pull connecting rod mechanism comprises a first connecting rod and a second connecting rod, an inner end of the first connecting rod is rotatably connected to the middle connecting frame, an outer end of the first connecting rod is rotatably connected to an inner end of the second connecting rod, and an outer end of the second connecting rod is connected to the reverse stroke amplification connecting structure; the second connecting rod is also slidably connected to the rotatable connecting arm, the position of a slide rail for the sliding connection, the position of the axis of rotational connection between the first connecting rod and the middle connecting frame, and the position of the axis of rotational connection between the first connecting rod and the second connecting rod are coordinated such that, when the foldable mobile terminal having a flexible screen is in the inward-folding closed state, the axis of rotational connection between the first connecting rod and the middle connecting frame is closer to a center line of the middle connecting frame than the axis of rotational connection between the first connecting rod and the second connecting rod;
the first connecting rods of the hinges at the first end and the second end are combined into a plate extending from the first end to the second end, forming a shielding structure.

7. The hinge module for a foldable mobile terminal having a flexible screen according to claim 5, wherein the hinge is provided with a locking structure for locking a current angle when the hinge is opened or folded to different angles.

8. The hinge module for a foldable mobile terminal having a flexible screen according to claim 6, wherein a rotatable connecting shaft between the first connecting rod and the middle connecting frame is configured to slide axially, and an end thereof is provided as a lock head and supported axially by a spring, a plurality of lock grooves matching the lock head are provided around a rotatable connecting shaft of the rotatable connecting arm.

9. The hinge module for a foldable mobile terminal having a flexible screen according to claim 5, wherein the shafts connected to both ends of the middle chain link are rotatably connected to the middle connecting frame, and both ends of the linkage module are rotatably connected to the rotatable connecting arms of the left motion structure and the right motion structure at positions offset from the axis of rotation of the rotatable connecting arms.

10. The hinge module for a foldable mobile terminal having a flexible screen according to claim 5, wherein the number of chain links in the row where the middle chain link is located is five, the number of middle support plates is five, and the width of the middle support plates on both sides is greater than that of the three middle support plates therebetween.

11. The hinge module for a foldable mobile terminal having a flexible screen according to claim 5, wherein both ends of the linkage module are rotatably connected to the rotatable connecting arms of the left motion structure and the right motion structure at positions offset from the axis of rotation of the rotatable connecting arms.

12. The hinge module for a foldable mobile terminal having a flexible screen according to claim 10, wherein at least some of the middle support plates support the curved middle part of the flexible screen when the foldable mobile terminal having a flexible screen is in an outward-folding closed state.
